(19) United States
(12) Patent Application Publication
(10) Pub. No.: US 2019/0257668 A1
(43) Pub. Date: Aug. 22, 2019

(54) EXTENSIBLE METERING SYSTEM AND OPERATING METHOD THEREOF

(71) Applicant: SCHNEIDER ELECTRIC INDUSTRIES SAS, Rueil Malmaison (FR)

(72) Inventors: Jomy YOHANNAN, Bangalore (IN); Mohamed Sadakkathulla ABDUL SALAM, Bangalore (IN)

(21) Appl. No.: 16/278,747

(22) Filed: Feb. 19, 2019

(30) Foreign Application Priority Data
Feb. 21, 2018 (IN) 201841006585

(51) Int. Cl. G01D 4/00; G06Q 50/06

(52) U.S. Cl. CPC G01D 4/006; G01D 4/008; G06Q 50/06

(57) ABSTRACT

The invention relates to a network enabled extensible metering system and a method of operation. The system comprising a plurality of first electronic circuitries (102a, 102b . . . 102n) that may be configured to establish a connection between a plurality of meters (104a, 104b . . . 104n and a mobility device (114) based on one or more parameters of the plurality of meters (104a, 104b . . . 104n). The system further comprising a second electronic circuitry (106) that may be configured to process an information of the plurality of meters (104a, 104b . . . 104n) connected with the mobility device (114) in the metering system (100). The third electronic circuitry (108) in the system may be configured to synchronously transmit the processed information to a display (110) of the mobility device (114). The information from the processed information may be displayed on the display (110) of the mobility device (114) based on a user subscription request.

### TECHNICAL FIELD

The invention generally relates to metering system. More particularly, the present invention relates to the network enabled extensible metering system and its operating method.

### BACKGROUND

Due to an improvised digitization in all fields, the increased application complexity in the configuration of the meter leads to a higher probability of errors that may require upgrades. Further, the increased application functionality housed in the meter typically requires complex configuration or programming of the end-device, which greatly increases the system management, coordination, and synchronization; and meter inventory must be increased in order to accommodate different configurations, functionalities, and versions of metering devices.

Currently each meter has as separate display which will show the different metering data. Therefore, to measure new sets of measurement point new meters need to be added or upgrade the system. Every additional meter that is added will need to considered for additional communication equipment in addition to the additional space needed in the panel and this will take more time and effort to implement the same. Further, the current metering systems also lags in adaptability of the new improvised system capabilities in terms of measuring and responding to the fluctuations in the quantity under measurement.

Additionally, this increases the requirement of more infrastructure, increase in cost, and delay in outage restorations.

Accordingly, there is an unmet need to provide a network enabled extensible metering system which overcomes the limitations of the prior art.

The teachings herein extend to those embodiments which fall within the scope of the appended claims, regardless of whether they address one or more of the above-mentioned problems.

### OBJECTS OF THE INVENTION

One object of the present invention is to provide an extensible metering system.

Another object of the present invention is to provide a network enable extensible metering system.

Yet another object of the invention is to provide a method of operating the network enable extensible metering system.

Yet another object of the present invention is to provide a system and method by which new features can be easily enabled in the meter(s).

Yet another object of the present invention is to retrofit applications in the meters and therefore easily manage the customer sites.

Yet another object of the present invention is to reduce the replacement of the meters due to change in the features.

Yet another object of the present invention is to provide the up gradation in the platform of the mobility enabled devices.

Yet another object of the present invention is to provide license based applications in the metering system(s).

Yet another object of the present invention is to provide peer to peer pairing between the meters and network enabled devices in the system.

Yet another object of the present invention is to perform one or more operations based on user subscription.

These and other aspects as well as advantages will be more clearly understood from the following description taken in conjunction with the accompanying drawings.

### SUMMARY

A network enabled extensible metering system is disclosed. The system comprising a plurality of first electronic circuitries (102a, 102b . . . 102n). The plurality of first electronic circuitries may be configured to establish a connection between a plurality of meters (104a, 104b . . . 104n and a mobility device (114). Further, the connection may be established based on one or more parameters of the plurality of meters (104a, 104b . . . 104n). The system further comprising a second electronic circuitry (106). The second electronic circuitry may be configured to process an information of the plurality of meters (104a, 104b . . . 104n) connected with the mobility device (114) in the metering system (100). The system further comprising a third electronic circuitry (108) configured to synchronously transmit the processed information to a display (110) of the mobility device (114). The information from the processed information may be displayed on the display (110) of the mobility device (114) based on a user subscription request.

A method for operating network enabled extensible metering system is disclosed. The method comprising establishing a connection between a plurality of meters (104a, 104b . . . 104n) and a mobility device (114). The connection may be established based on one or more parameters of the plurality of meters (104a, 104b . . . 104n). The method further includes processing information of the plurality of meters (104a, 104b . . . 104n) connected with the mobility device (114) in the metering system. The method further includes transmitting the processed information to a display (110) of the mobility device (114). Further, at least an information from the processed information may be displayed on the display (110) of the mobility device (114) based on a user subscription request.

### BRIEF DESCRIPTION OF THE ACCOMPANYING DRAWINGS

To further clarify advantages and aspects of the invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings, which are listed below for quick reference.

FIG. 1 illustrates a block diagram of network enabled extensible metering system, in accordance with the embodiment of the present invention;

FIG. 2 illustrates a block diagram of metering system in an electrical panel, in accordance with the embodiment of the present invention;

FIG. 3 illustrates a block diagram for data transfer to display system in extensible metering system, in accordance with the embodiment of the present invention;

FIG. 4 illustrates a block diagram of a network system in extensible metering system, in accordance with the embodiment of the present invention; and

FIG. 5 illustrates a flow chart for method of operating network enabled extensible metering system, in accordance with the embodiment of the present invention.

It may be noted that to the extent possible, like reference numerals have been used to represent like elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the invention. Furthermore, the one or more elements may have been represented in the drawings by conventional symbols, and the drawings may show only those specific details that are pertinent to understanding the embodiments of the invention so as not to obscure the drawings with details that will be readily apparent to those of ordinary skill in the art having benefit of the description herein.

### DETAILED DESCRIPTION

It should be understood at the outset that although illustrative implementations of the embodiments of the present disclosure are illustrated below, the present invention may be implemented using any number of techniques, whether currently known or in existence.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments.

Accordingly, the term “some embodiments” is defined as meaning “no embodiment, or one embodiment, or more than one embodiment, or all embodiments.” The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium (memory) includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or determining or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

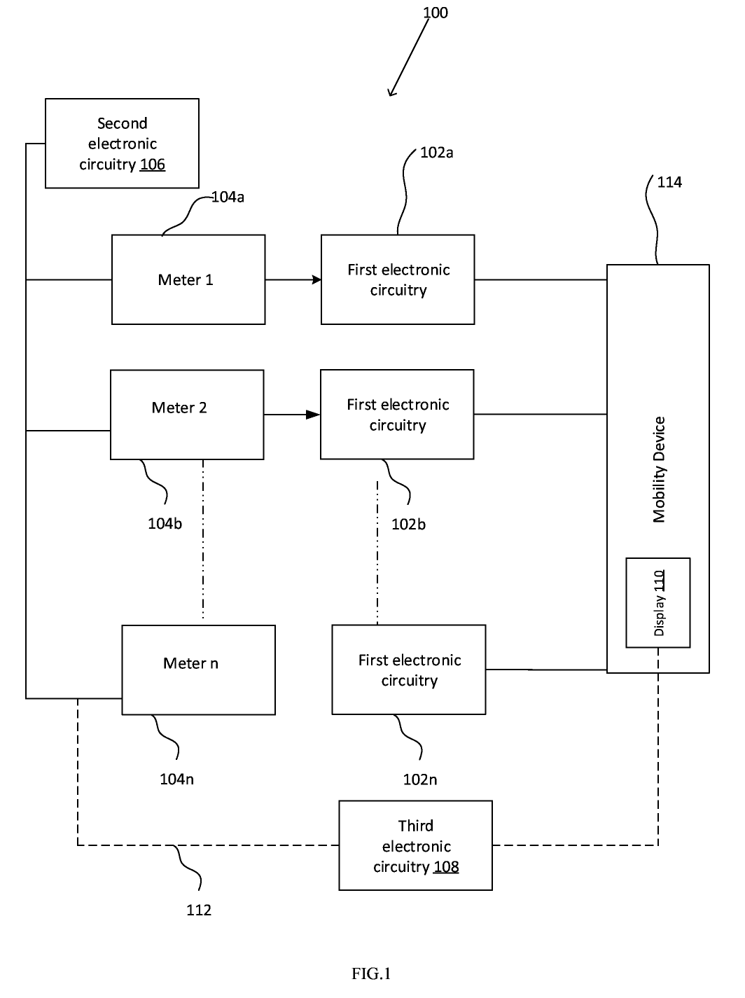

FIG. 1 illustrates a block diagram of network enabled extensible metering system, in accordance with the embodiment of the present invention.

In FIG. 1, a block diagram of network enabled extensible metering system 100 is shown. The network enabled extensible metering system 100 comprises of a plurality of first electronic circuitries 102a, 102b . . . 102n, a plurality of meters 104a, 104b . . . 104n, a second electronic circuitry 106, a third electronic circuitry 108, a display device 110, a network 112, and a mobility device 114.

The plurality of first electronic circuitries 102a, 102b . . . 102n includes suitable logic, circuitry, and/or interfaces that may be configured to establish a connection between a plurality of meters 104a, 104b . . . 104n and a mobility device 114. Further, each of the plurality of meters 104a, 104b . . . 104n and the mobility device 114 may be connected via the plurality of first electronic circuitries 102a, 102b . . . 102n based on one or more parameters of the plurality of meters 104a, 104b . . . 104n.

In an embodiment of the present invention, upon receiving the connection request from each of the plurality of meters 104a, 104b . . . 104n, the mobility device 114 may send a notification via the plurality of first electronic circuitries 102a, 102b . . . 102n for confirmation of connection establishment.

In an embodiment, the connection establishment between the plurality of meters 104a, 104b . . . 104n and the mobility device 114 may be based on one or more parameters. These one or more parameters pertain to parameters of the meter.

The plurality of meters 104a, 104b . . . 104n includes suitable logic, circuitry, and/or interfaces that may be configured to read and store a plurality of electronic units. These plurality of electronic units may include, but not limited to a current, a voltage, and alike.

In an embodiment of the present invention, each of the meters may include a sensor based electronic unit device for reading the plurality of electronic units. Further, it may also include an analog to digital convertor to convert the analog readings to digital readings and further processing these readings.

In an embodiment of the present invention, the one or more parameters of the plurality of meters 104a, 104b . . . 104n may correspond to a system based automatically detected one or more parameters such as, the electronic unit under reading by the system, its related terms, and alike.

In an exemplary embodiment, the one or more parameter based on which the connection may be established may be temperature reading of the system. The system may detect a rise in temperature which might have exceed the cut off temperature of the system (default), then the connection may not been established.

In an alternate embodiment, the one or more parameters may be user defined parameters, such as, but not limited to, user defined preference of current statistics, a voltage statistics, an user subscription type, and alike.

The second electronic circuitry 106 includes suitable logic, circuitry, and/or interfaces that may be configured to process an information of the plurality of meters 104a, 104b . . . 104n that may be connected with the mobility device 114 as described in the above description of the plurality of first electronic circuitries 102a, 102b . . . 102n.

In an embodiment of the present invention, the second electronic circuitry 106 may include a controller that may correspond to an electronic device that is coupled to the plurality of other devices through communication network. The controller includes suitable logic, circuitry, and/or interfaces that are operable to execute one or more instructions stored in the memory unit to process the information. The controller may be implemented using one or more processor technologies known in the art. Examples of the controller include, but are not limited to, an x86 microprocessor, a RISC microprocessor, an ASIC microprocessor, a CISC microprocessor, or any other microprocessor. Further, in an embodiment, the controller may be capable of performing more than one operation in parallel. For example, the controller may be a multi-threaded processor, which may execute more than one process concurrently. Each such process may be executed to perform an operation, for e.g. processing of the information, filtration of the information and alike.

The second electronic circuitry 106 may further include a memory unit that may include suitable logic, circuitry, and/or interfaces that are operable to store the various readings. The memory unit may be operable to store the one or more instructions. The memory unit may store the time interval defined by the user to continuously monitor the information of the system. Further, the memory may correspond to a RAM type or a ROM type. Further, the memory unit may be communicatively attached to the rest of the system and collects the data from all sensors and other integrated devices.

The third electronic circuitry 108 includes suitable logic, circuitry, and/or interfaces that may be configured to transmit the processed information to a display 110 of the mobility device 114.

In an embodiment, the entire information may be processed and sent to the mobility device 114, but the display 110 associated with the mobility device 114 may display only the information from the entire processed information, for which the user may have subscribed. Therefore, the display of information from the entire processed information may be based on user requirements.

In an embodiment, the third electronic circuitry 108 may be paired firstly with the mobility device 114 prior to displaying the processed information on the display 110. Further, the pairing may be a manual pairing or an automatic pairing. In an embodiment, the manual pairing may be operable based on a unique identification code third electronic circuitry 108. The user may provide the unique identification code in the display 110, which in turns triggers a request to the third electronic circuitry 108. Further, the third electronic circuitry 108 may send a confirmation ID to the display 110, and based on the confirmation, the pairing request may be enabled for transmission of information between the third electronic circuitry 108 and the display 110.

In an alternate embodiment, the automatic pairing may be initiated by the data display application in the display 110, by sending a pairing broadcast request to all the unpaired third electronic circuitry with relevant information like device type, application license enable information etc. Upon receiving the broadcast, all the third electronic circuitry which supports device type may respond back to the data display application with its own unique device identification. Thereafter, the user may select at least a unique identification listed in the data display application. Further, the data display application in the display may send a pairing request to the third electronic circuitry with relevant information like device type, application license enable information etc. The third electronic circuitry may process this information and send the confirmation id to the data display application.

Additionally, if information is not relevant for the third electronic circuitry, it may return an error to the Data Display Application or if the pairing is successful, Data Display Application will initiate a connection request, and a flag may be displayed on the display.

In an embodiment, the user may alter the subscription based on the requirements. This may also help the user to save the cost of the entire system, and further may reduce the system burden. The user associated with the subscription may also alter the one or more parameters of the meters.

In an alternate embodiment, a data control module in the system may automatically modify the one or more parameters in the plurality of meters based on pre stored system characteristics.

In an exemplary embodiment, the user may upgrade the subscription, therefore the one or more parameters of the connected meter may get modified and the user may get more detailed processed information on the display associated with the mobility device 114.

The display 110 may comprise suitable logic, circuitry, interfaces, and/or code that may be operable to render a display. In an embodiment, the display device may be connected to the controller. Further, the display unit may have illumination for an easy display of the processed information.

The display 110 may be further integrated with the communication network to communicate the data to the remotely located servers. Furthermore, the display 110 may be communicatively coupled with the plurality of first electronic circuitries 102a, 102b . . . 102n, the plurality of meters 104a, 104b . . . 104n, the second electronic circuitry 106, the third electronic circuitry 108, and the mobility device 114 through the network 112.

The network 112 may correspond to a communication network that may include connections such as wire, wireless communication links, or fiber optic cables. The communication network may also be implemented using WLAN, Bluetooth or any other communication technology. The communication network may employ any network topology, transmission medium, or network protocol.

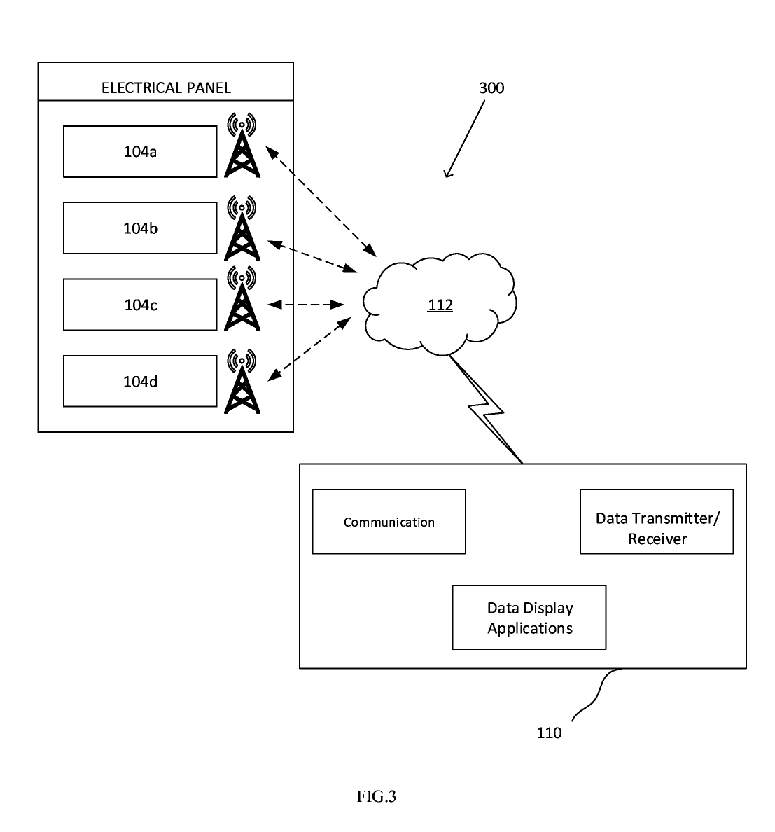

The mobility device 114 may comprise suitable logic, circuitry, interfaces, and/or code and may include a plurality of modules, such as communication module, data transmission and reception module, and a data display application module. These modules may be electronic modules configured to perform one or more specific functions. The different modules of the mobility device 114 are explained in FIG. 3.

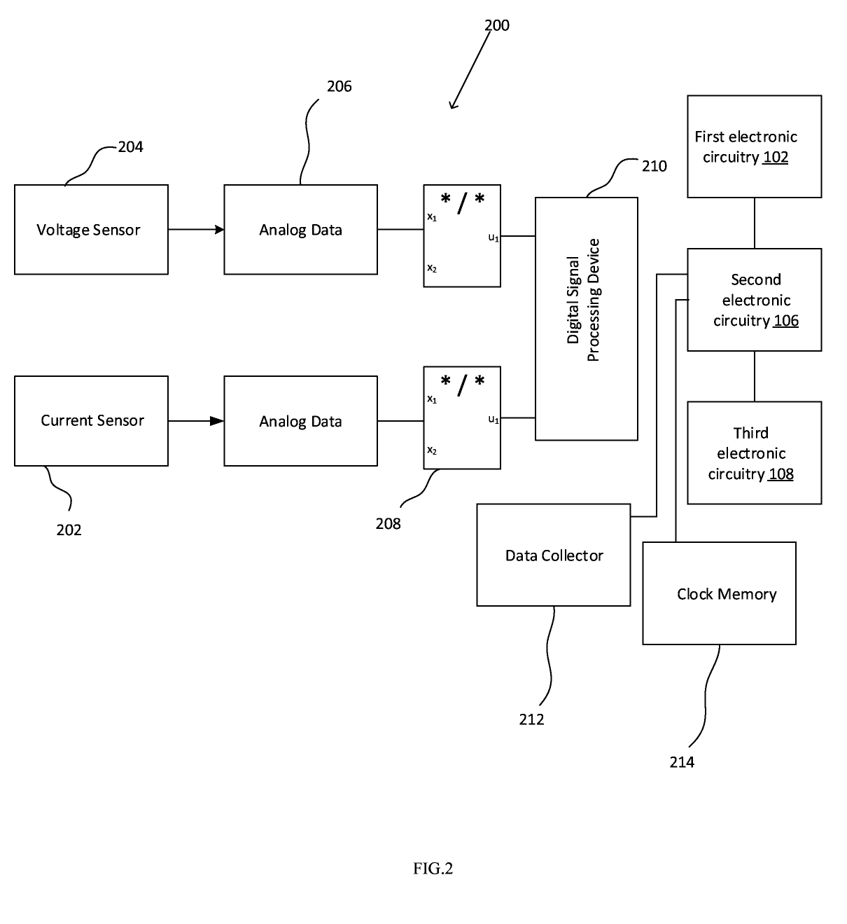

FIG. 2 illustrates a block diagram of metering system in an electrical panel, in accordance with the embodiment of the present invention.

In FIG. 2, a block diagram 200 of metering system in an electrical panel is shown. The system 200 comprises of a current sensor 202, a voltage sensor 204, an analog data module 206, an analog to digital converter 208, a digital signal processing device 210, a data collection module 212, a clock memory 214, the first electronic circuitry 102, the second electronic circuitry 106, and the third electronic circuitry 108.

The current sensor 202 may comprise suitable logic, circuitry, interfaces, and/or code that may be operable to sense the current. In an embodiment of the present invention, the current sensor 202 may further have a protection circuit. This protection circuit enables the current sensor 202 to protect against the sudden rise in the current value, which may be beyond a pre-defined value.

The voltage sensor 204 may comprise suitable logic, circuitry, interfaces, and/or code that may be operable to sense the voltage. In an embodiment of the present invention, the voltage sensor 204 may further have a protection circuit. This protection circuit enables the voltage sensor 204 to protect against the sudden rise in the voltage value, which may be beyond a pre-defined value.

The analog data module 206 may comprise suitable logic, circuitry, interfaces, and/or code that may be operable to store the analog data sensed by the current sensor 202 and/or the voltage sensor 204.

The analog to digital converter 208 may comprise suitable logic, circuitry, interfaces, and/or code that may be operable to convert the analog data sensed by the sensors to digital form. The digitally converted data may be in digital form, i.e digital signals.

The digital signal processing device 210 may comprise suitable logic, circuitry, interfaces, and/or code that may be operable to process the digitally converted data and may further filter the data prior to storing in the data collection module 212. Further, the digital signal processing device 210 may include protection circuitry for protection. The digital signal processing device 210 may further process the collected data into information. The processed information may be a meaningful analysis of various reading obtained from the received data.

The data collection module 212 may comprise suitable logic, circuitry, interfaces, and/or code that may be operable to collect the data. The data collection module may be communicatively attached to the digital signal processing device 210 for transfer of the processed information.

The clock memory 214 may comprise suitable logic, circuitry, interfaces, and/or code that may be operable to trigger the system in pre-defined intervals to transmit the processed information from the data collection module 212 to the display associated with the mobility device. In an embodiment, information from the processed information may be displayed on the display based on the subscription of the user.

The first electronic circuitry 102, the second electronic circuitry 106, and the third electronic circuitry 108 functions as described in FIG. 1.

FIG. 3 illustrates a block diagram for data transfer to display system in extensible metering system, in accordance with the embodiment of the present invention.

In FIG. 3, a block diagram 300 for data transfer to display system in extensible metering system is shown. The system 300 comprises of the plurality of meters (104a, 104b, 104c, and 104d), the network 112, and the display device 110.

As shown in FIG. 3, the electrical panel may comprise the plurality of meters (104a, 104b, 104c, and 104d) connected through a wireless network 112 to communicate with the display device 110. Further, the display device 110 may comprise one or more modules such as a communication enabler module, a data streaming module, and a data display applications module. These modules may be configured to perform one or more specific functions.

The communication enabler module may be configured to manage connections to all the plurality of meters (104a, 104b, 104c, and 104d). In an embodiment, the communication enabler module may be further configured to enable a request from the meter based on modification of the one or more parameters. Based on the modification, the one or more applications may be launched.

The data streaming module may be configured to transmit the processed information to the display 110 associated with the mobility device 114. Based on the one or more parameters, the data streaming module may further regulate the transmission of processed information to the display 110. In addition the devices in the electric panel may be regulated based on the modification in the one or more parameters. Further, this module may also enable a time specific transmission of the processed data.

The data display applications module may correspond to a plurality of applications for each of the one or more devices installed in the system. The user may install and/or de-install these system based applications by modifying one or more parameters, and therefore can directly control the one or more devices installed in the system. Therefore, by modifying the one or more parameters the user may alter the displayed processed information. Further, this is based on subscription of the user.

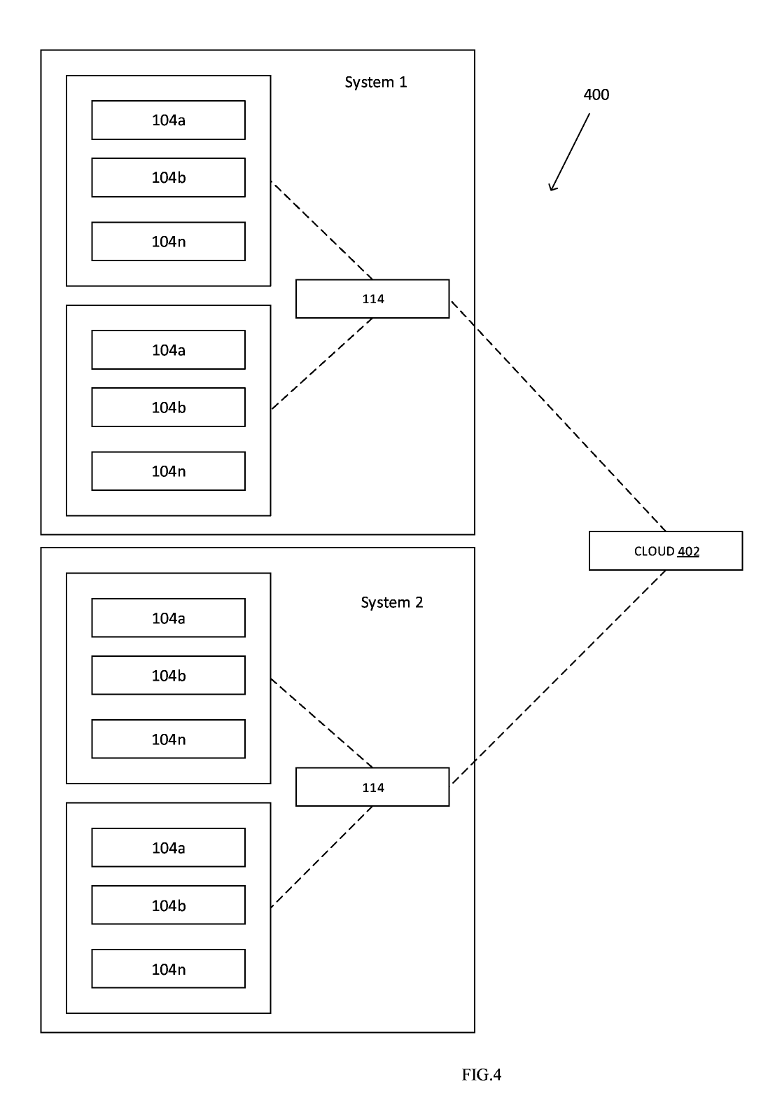

FIG. 4 illustrates a block diagram of a network system in extensible metering system, in accordance with the embodiment of the present invention.

In FIG. 4, a block diagram 400 of an exemplary network system in extensible metering system is shown. The block diagram 400 comprises plurality of meters (104a, 104b . . . 104n) in panel 1 and plurality of meters (104a, 104b . . . 104n) in panel 2 of system 1, and plurality of meters (104a, 104b . . . 104n) in panel 1 and plurality of meters (104a, 104b . . . 104n) in panel 2 of system 2, a mobile device 114, and a cloud 402.

In the exemplary block diagram 400, the system 1 comprises of the panel 1 and panel 2 in the electrical distribution system panel. Further, each of the panel comprises a plurality of meters (104a, 104b . . . 104n), a mobile device 114, and a cloud 402. The system 2 also comprises of the panel 1 and panel 2 in the electrical distribution system panel. Further, each of the panel comprises a plurality of meters (104a, 104b . . . 104n). These 2 systems may be communicatively coupled through the network and may communicate with the cloud 402. The cloud 402 may provide storage space for storing the processed information.

In the exemplary embodiment, the plurality of meters (104a, 104b . . . 104n) may be connected with the mobility device 114, through the network. The display 110 associated with the mobility device 114 may have pre-authorized applications, and access to the default processed information. The user based on the requirements may modify the one or more parameters and therefore may change the subscription accordingly. The change in the subscription may provide an additional access to the processed information to the user, and hence the same plurality of meters (104a, 104b . . . 104n) may be utilized for better access to the information of the plurality of other electronic devices which may be a part of the entire assembly.

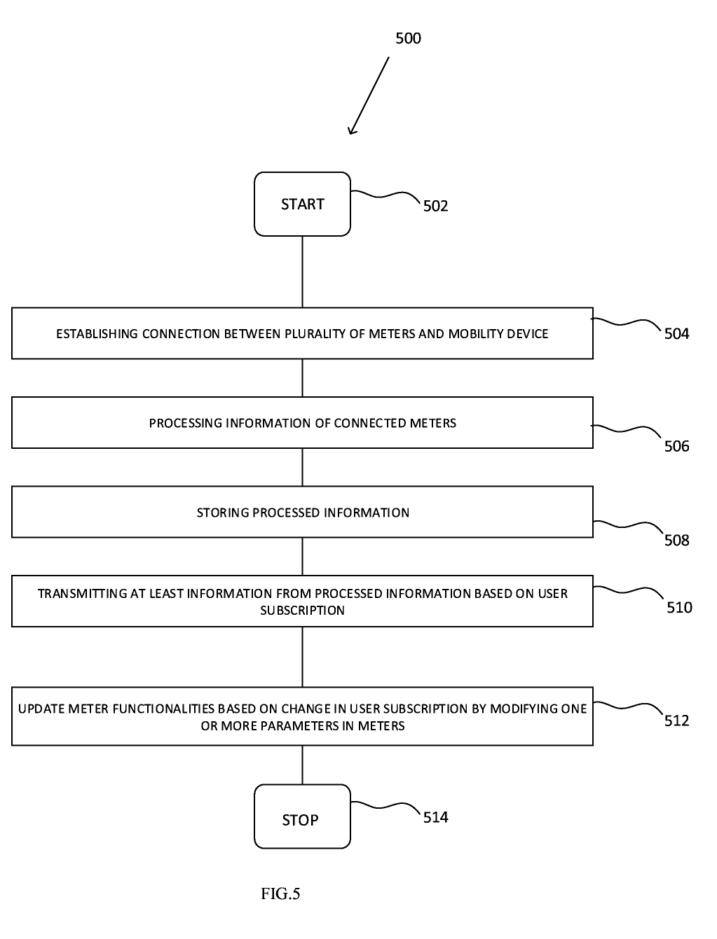

FIG. 5 illustrates a flow chart for method of operating network enabled extensible metering system, in accordance with the embodiment of the present invention.

Process starts at step 502.

At step 504 a connection may be established. In an embodiment, a plurality of first electronic circuitries 102a, 102b . . . 102n may be configured to establish a connection between a plurality of meters 104a, 104b . . . 104n and a mobility device 114.

The connection may be established based on one or more parameters. The one or more parameters may correspond to the parameters of the plurality of meters. These parameters may be further modified based on the system requirements or based on the user requirements. The meters may provide one or more functions based on these parameters. Further, any modification in these one or more parameters may result in change in the output from the plurality of meters 104a, 104b . . . 104n.

In an embodiment of the present invention, upon receiving the connection request from each of the plurality of meters 104a, 104b . . . 104n, the mobility device 114 may send a notification via the plurality of first electronic circuitries 102a, 102b . . . 102n for confirmation of connection establishment.

At step 506, information may be processed. The second electronic circuitry 106 may be configured to process an information of the plurality of meters 104a, 104b . . . 104n that may be connected with the mobility device 114 in step 504.

Prior to the processing of information, the information may be converted to digital readings from the analog readings by use of analog to digital converter.

At step 508, the processed information may be stored. In an embodiment, the memory unit may be configured to store the processed information for further transmission.

Further the processed information may be an analysis of all the readings, which may be read by the plurality of meters.

At step 510, information from the processed information may be displayed. The display device may be configured to display at least information from the processed information. The display of the information may be based on the subscription of the user.

The various applications on the display of the mobility device 114 may be enabled based on the subscription of the user, which may further provide the processed information as per the subscription availed by the user.

At step 512, meter functionalities may be updated. In an embodiment, the one or more parameters of the meters may be modified by the user to change the access of the functionalities of the meters. Further, this may further change the subscription of user and the user may have more access to the desired processed information.

Prior to this, the connection between a third electronic circuitry 108 and a mobility device 114 may be established by the network 112. In an embodiment, the third electronic circuitry may be attached to each of the plurality of meters. In an embodiment, the third electronic circuitry 108 may be paired firstly with the mobility device 114 prior to displaying the processed information on the display 110. Further, the pairing may be a manual pairing or an automatic pairing.

In an embodiment, the manual pairing may be operable based on a unique identification code third electronic circuitry 108. The user may provide the unique identification code in the display 110, which in turns triggers a request to the third electronic circuitry 108. Further, the third electronic circuitry 108 may send a confirmation ID to the display 110, and based on the confirmation, the pairing request may be enabled for transmission of information between the third electronic circuitry 108 and the display 110.

In an alternate embodiment, the automatic pairing may be initiated by the data display application in the display 110, by sending a pairing broadcast request to all the unpaired third electronic circuitry with relevant information like device type, application license enable information etc. Upon receiving the broadcast, all the third electronic circuitry which supports device type may respond back to the data display application with its own unique device identification. Thereafter, the user may select at least a unique identification listed in the data display application. Further, the data display application in the display may send a pairing request to the third electronic circuitry with relevant information like device type, application license enable information etc. The third electronic circuitry may process this information and send the confirmation id to the data display application.

The process ends at step 514.

While certain present preferred embodiments of the invention have been illustrated and described herein, it is to be understood that the invention is not limited thereto and can be practiced within the scope of the present invention. The features and functions of the system, as well as alternative embodiments disclosed herein may be combined into many other different systems or applications. Various presently unforeseen or unanticipated alternatives, modifications, variations or improvements may be made by those skilled in the art, each of which is also intended to be encompassed by the disclosed embodiments and claims.

We claim:

1. A network (112) enabled extensible metering system (100) comprising:
a plurality of first electronic circuitries (102a, 102b . . . 102n) configured to establish a connection between a plurality of meters (104a, 104b . . . 104n and a mobility device (114), wherein said connection is established based on one or more parameters of said plurality of meters (104a, 104b . . . 104n);
a second electronic circuitry (106) configured to process an information of said plurality of meters (104a, 104b . . . 104n) connected with said mobility device (200) in said metering system (100); and
a third electronic circuitry (108) configured to synchronously transmit said processed information to a display (110) of said mobility device (114), wherein at least an information from said processed information is displayed on said display (110) of said mobility device (114) based on a user subscription request.

2. The network (112) enabled extensible metering system (100) as claimed in claim 1 wherein said display device comprises a data control module to modify said one or more parameters in said plurality of meters (104a, 104b . . . 104n).

3. The network (112) enabled extensible metering system (100) as claimed in claim 1 wherein said display device comprises a communication enabling module configured to enable one or more pre requisite applications based on one or more request from said plurality of meters (104a, 104b . . . 104n).

4. The network (112) enabled extensible metering system (100) as claimed in claim 1 wherein said third electronic circuitry and said display device is paired to display said transmitted data.

5. The network (112) enabled extensible metering system (100) as claimed in claim 4 wherein said pairing is a manual pairing or an automatic pairing.

6. The network (112) enabled extensible metering system (100) as claimed in claim 1, wherein one or more applications are activated on each of said plurality of meters (104a, 104b . . . 104n) on a real time basis.

7. The network (112) enabled extensible metering system (100) as claimed in claim 1 comprising a database coupled to said network (112) to store one or more pre-defined user instructions.

8. A method (500) for operating network (112) enabled extensible metering system (100) comprising:
establishing, by a plurality of first electronic circuitries (102a, 102b . . . 102n), a connection between a plurality of meters (104a, 104b . . . 104n) and a mobility device (114), wherein said connection is established based on one or more parameters of said plurality of meters (104a, 104b . . . 104n);
processing, by a second electronic circuitry, an information of said plurality of meters (104a, 104b . . . 104n) connected with the mobility device (200) in said metering system; and
transmitting, by a third electronic circuitry, said processed information to a display (110) of said mobility device (114), wherein at least information from said processed information is displayed on said display (110) of said mobility device (114) based on a user subscription request.

9. The method (500) for operating network enabled extensible metering system (100) as claimed in claim 8 comprising modifying one or more parameters in said plurality of meters (104a, 104b . . . 104n) by a data control module in said display device.

10. The method (500) for operating network enabled extensible metering system (100) as claimed in claim 8 comprising enabling one or more pre requisite applications in said display devices based on one or more request from said plurality of meters (104a, 104b . . . 104n).
